(19) United States
(12) Patent Application Publication
(10) Pub. No.: US 2005/0178438 A1
(43) Pub. Date: Aug. 18, 2005

(54) Flexible and extendable plumbing trap device

(76) Inventor: Brian K. Renner, Cleveland, MO (US)

Correspondence Address: CHASE LAW FIRM L.C, 4400 COLLEGE BOULEVARD, SUITE 130, OVERLAND PARK, KS, 66211, US

(21) Appl. No.: 10/781,297

(22) Filed: Feb. 18, 2004

(51) Int. Cl. F16K 13/00

(52) U.S. Cl. 137/247.41

(57) ABSTRACT

A plumbing trap having flexible and extensible arms that allow installation of the trap between drain tail pieces and drain outlets of various spacings and orientations while reducing the need for cutting trap elements during installation or assembly of a trap from multiple components.

### FIELD OF THE INVENTION

The invention relates to plumbing fixtures and, in particular, to a plumbing trap device with portions that provide sufficient flexibility and axial extension and retraction to allow the trap to be installed between plumbing fixtures, such as drains and drain outlets, of various spacings. The present invention also relates to a plumbing trap device having flexible and extensible inlet arm and outlet arm sections for facilitating installation of the trap between drain and outlet fixtures of various spacings without the need for assembling the trap from multiple components, or cutting the components, to fit a particular spacing arrangement.

### BACKGROUND OF THE INVENTION

When installing a common plumbing trap, a plumber must be able to align the inlet of the trap with the tail piece of the plumbing fixture so that they are in straight vertical alignment, often incorporating an intermediate extension tube also referred to as a tail extension piece. Because the outlet of the trap is connected to a horizontal connector arm that attaches to a drain outlet, the vertical axis of the tail piece and the horizontal axis of the drain outlet and connector arm should be in perpendicular alignment. In addition, the space provided between the tail piece and drain outlet should be large enough to accommodate the trap structure. Unfortunately, the axes are often not in perpendicular alignment and often the space provided between the tail piece and drain outlet is not large enough to readily accommodate plumbing traps in the prior art.

Therefore, there is a need for a plumbing trap device whereby both the inlet portion of the trap and the outlet portion of the trap may each be both flexed and adjusted in length to allow the trap to be positioned outside of the vertical axis of the tail piece and the horizontal axis of the drain outlet, and yet function as required. This need is evidenced by the numerous patents that have been obtained purporting to solve this problem. In addition, it would be advantageous for such a trap to be of unitary construction thereby minimizing the need for on-site assembly of the trap from sub-elements selected to meet the particular spacing arrangement presented by the drain and outlet. None of these references, however, presents the novel combination of features presented by the present invention.

Several prior art patents disclose devices that attempt to solve the problem by providing a flexible trap element. These references are exemplified by the patents to Lamond, U.S. Pat. No. 4,516,278 and Bresnahan, U.S. Pat. No. 5,063,616. Both patents disclose various traps formed of soft, flexible material that allows the trap to be manually manipulated to dislodge obstructions. The traps also provide flexion that allows the tail extension and arm connector pieces to be slightly altered in orientation to adapt to a particular drain and drain outlet spacing arrangement. These traps present structures similar to curved lengths of rubber or soft plastic tubing and therefore, while providing flexibility, also present some disadvantages. For example, both patents disclose attaching the flexible trap to further plumbing components to complete the trap assembly. Attachment is disclosed in both patents as utilizing common hose clamps for providing radial compression upon the end of the trap structure since the flexible structure is not amenable to more common plumbing connectors, such as threaded nuts and gaskets. Apart from being the less desired method of attaching household drain fixtures, hose clamps are typically formed of metal components which are liable to rust under the damp conditions usually associated with plumbing drains. A further problem presented by flexible traps, such as those disclosed in Lamond and Bresnahan, is that the soft material does not lend itself to the inclusion of a clean out aperture in the lower portion of the trap. Both the lack of a clean out aperture, and the flexibility of the trap itself, often render such devices unusable as they do not pass common plumbing code enacted by most local governments.

The patents to Danks, patent No. Des. 231,930; Wirth, U.S. Pat. No. 3,860,978 and Doyle, patent No. Des. 346,646 offer a somewhat different solution by providing flexible plumbing traps comprised of accordion pleats. While providing flexibility, such arrangements also present disadvantages in that the flexible trap portion will not meet most plumbing code restrictions, is not amenable to the provision of a clean out plug, and due to the physical structure of the pleats, tends to collect debris within the trap itself necessitating dismantling the trap.

The patents to Itzler, U.S. Pat. No. 4,081,190 and Mikol, U.S. Pat. No. 4,846,510 disclose highly similar devices that also propose to alleviate the problem presented by varying spatial relationships between drains and drain outlets. Both of these patents disclose a flexible tail extension piece that may be used to connect the tail piece of a plumbing fixture, such as a drain, to the inlet of a plumbing trap. While presumably solving a portion of the problem presented, such structures still present deficiencies in that they require assembly of multiple components on-site and specifically disclose the need to cut portions of the tail extension to accommodate alignment in various situations.

The patent to Olive, U.S. Pat. No. 3,967,324, discloses a plumbing trap having a connector arm that has a flexible, corrugated section. As disclosed, the trap may be bent away from the longitudinal axis of the arm element, due to the flexibility provided by the corrugated section. The patent, however, does not disclose a section that also provides extension and compression of the flexible section, nor does it disclose a unitary body having flexible and extensible sections incorporated into both the inlet arm and the outlet arm.

### BRIEF SUMMARY OF THE INVENTION

The present invention provides an improved plumbing trap device. In particular, the invention provides a plumbing trap device having a unitary, tubular body which may be flexed, compressed or expanded to fit a range of installation requirements.

In accordance with one aspect of the present invention, a plumbing trap device is provided which includes a unitary, tubular body for conveying waste water from a sink, tub or other source to a drain outlet. The body of the plumbing trap device includes a generally U-shaped trap section having a fluid-receiving inlet and a discharge outlet. Typically the U-shaped trap section presents a bent or molded portion of tubing having upwardly extending legs and a curved, relatively horizontal mid-section.

The U-shaped trap section could, however, be formed from a vessel having two transversely opposed openings in communication with the upper portion of the vessel, the openings being separated by a structure such as a wall or septum dividing the upper interior portion of the vessel into partially separated chambers connected by a gap in the wall in the lower portion of the vessel.

A tubular outlet arm extends from the discharge outlet and includes a flexible and extensible section. The end of the arm may have a nut and gasket or other means for connection to a drain outlet pipe or other fixture for receiving waste water. A tubular inlet arm extends from the inlet and also includes a flexible and extensible section. The end of the inlet arm may also have a nut and gasket, or other means for connection to the drain tail piece that delivers waste water from a sink, tub or other source to the plumbing trap.

The flexible sections are formed from a portion of the tubing that has been shaped to form pleats or corrugations. The flexible sections therefore present a length of tubing having a structure that may be described as an accordion or bellows. The flexible sections provide the inlet and outlet arms with sufficient flexibility, and axial extension and retraction, to facilitate installation of the plumbing trap device between plumbing fixtures, such as drains and drain outlets, of various spacings.

### BRIEF DESCRIPTION OF THE DRAWINGS

FIG. 1 is a side view of components comprising a plumbing trap in the prior art.

FIG. 2 is a reduced side view of a plumbing trap in the prior art illustrating spatial relationships between the trap and an associated fixture and drain outlet.

FIG. 3 is a side elevational view of a plumbing trap according to the present invention.

FIG. 4 is a front elevational view thereof.

FIG. 5 is a rear elevational view thereof.

FIG. 6 is a top view thereof.

FIG. 7 is a bottom view thereof.

FIG. 8 is a perspective view thereof.

FIG. 9 is a side elevational view thereof with pleated sections shown in compressed positions.

FIG. 10 is a side elevational view thereof with pleated sections shown in expanded positions.

FIG. 11 is a side elevational view thereof with pleated sections shown in flexed positions.

FIG. 12 is a side elevational view of the plumbing trap of FIG. 3 illustrating an alternative tail extension.

FIG. 13 is a side elevational view of a plumbing trap according to the present invention wherein the arm is bent downward to form an S-trap.

FIG. 14 is a longitudinal central section view of a plumbing trap of the present invention.

FIG. 15 is a side elevational view of an alternative embodiment of a plumbing trap.

### DETAILED DESCRIPTION

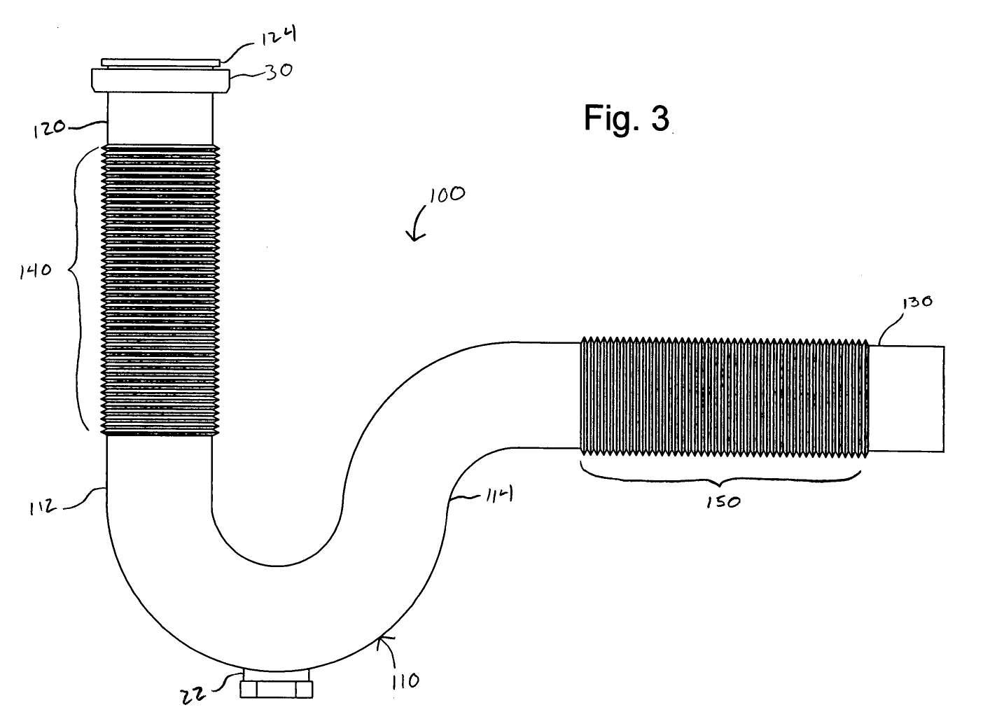

Referring more particularly to the drawings, and initially to FIGS. 3-8, there is shown a unitary, flexible and extendable plumbing trap device 100 including a generally U-shaped trap section 110 having inlet 112 and outlet 114 portions, a tubular inlet arm 120 communicating with the inlet 112 and a tubular outlet arm 130 communicating with the outlet 114, the device thereby providing a plumbing trap device 100 for receiving waste water or other fluid from the tail piece of a drain into the inlet arm 120 and delivering the fluid through the trap section 110 and outlet arm 130 to a drain outlet. To aid in the alignment of the plumbing trap device 100, when connected to the drain tail piece and drain outlet, both the inlet arm 120 and outlet arm 130 include flexible and extendable sections, 140 and 150 respectively, including a plurality of corrugations throughout the length of each section to allow the inlet arm and outlet arm 130 to flex, extend, and retract or compress to adapt the plumbing trap device for installation between plumbing fixtures of various spacings.

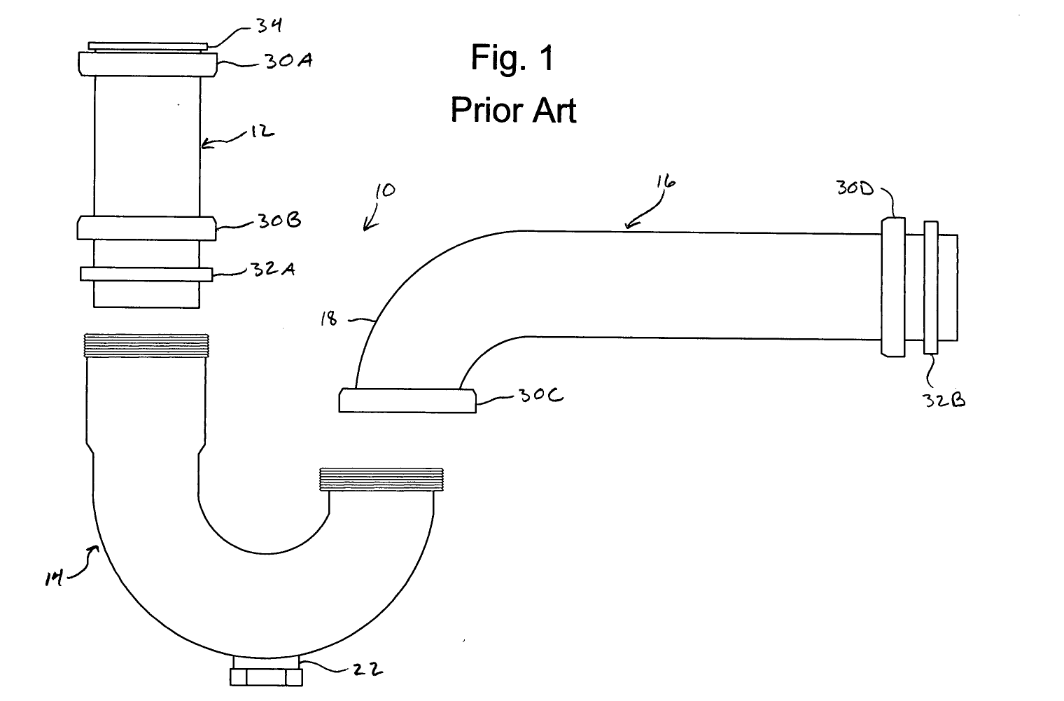

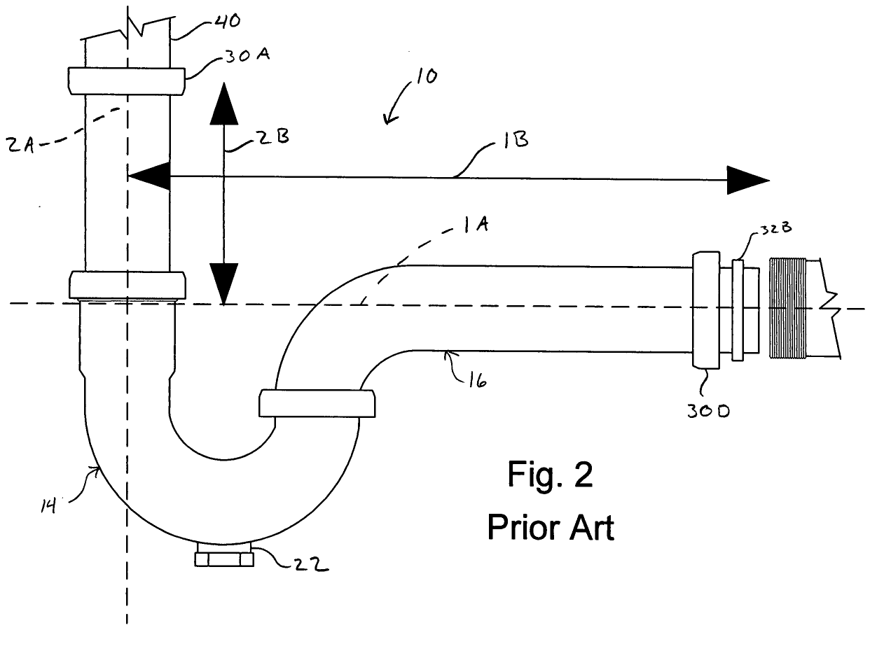

In order to illustrate the advantages of the present invention, a common plumbing trap of the prior art, often referred to as a P-trap 10, is illustrated in FIGS. 1 and 2. The P-trap 10 typically comprises three or more major components including a tail piece extension tube 12, a U-shaped trap 14 and an elongated connecting arm 16 having a downwardly curving portion 18 at one end for communicating with the outlet portion of the trap 14. The components for the P-trap 10 are typically assembled using threaded nuts 30A, 30B, 30C and 30D. Compressible gaskets 32A and 32B, or flanges 34 integral with the terminal ends of the arms, are typically used to connect the components to each other and the associated plumbing fixtures. Apart from the need to assemble these components to form the required P-trap 10, considerable difficulty often occurs due to the varied distances that may occur between the fixtures to be joined by the P-trap 10. The tail piece extension 12 and the connecting arm 16 need to be sized correctly to fit the space available. For the installer, this presents the necessity of bringing connecting arms 16 and tail piece extensions 12 of multiple lengths to a job site in order to assure having components of the required length. Even if tail piece extensions 12 and connecting arms 16 of multiple lengths are available, modifications are often required in order to achieve a fit. This is often addressed in the prior art by cutting a portion of either the connecting arm 16 or tail piece extension 12 with a saw to shorten the arm 16 or by joining additional lengths of tubing as required to extend the length of the arm 16.

FIG. 2 illustrates the above-referenced spatial variations that occur in different plumbing situations. Dashed line 1A, for example, illustrates the longitudinal axis of the drain outlet which typically projects from the wall of the room containing the lavatory or other plumbed fixture. Dashed line 2B indicates the vertical longitudinal axis corresponding to the tail piece 40 projecting from a sink or other fixture. Arrow 1B illustrates the critical horizontal distance between the drain outlet and the vertical axis 2A. Arrow 2B indicates the critical vertical distance between the tail piece 40 and the horizontal axis 1A.

The U-shaped trap 14 as illustrated in FIGS. 1 and 2 also typically incorporates a clean out aperture 22 which is used to extricate material lodged in the lower interior portion of the trap 14.

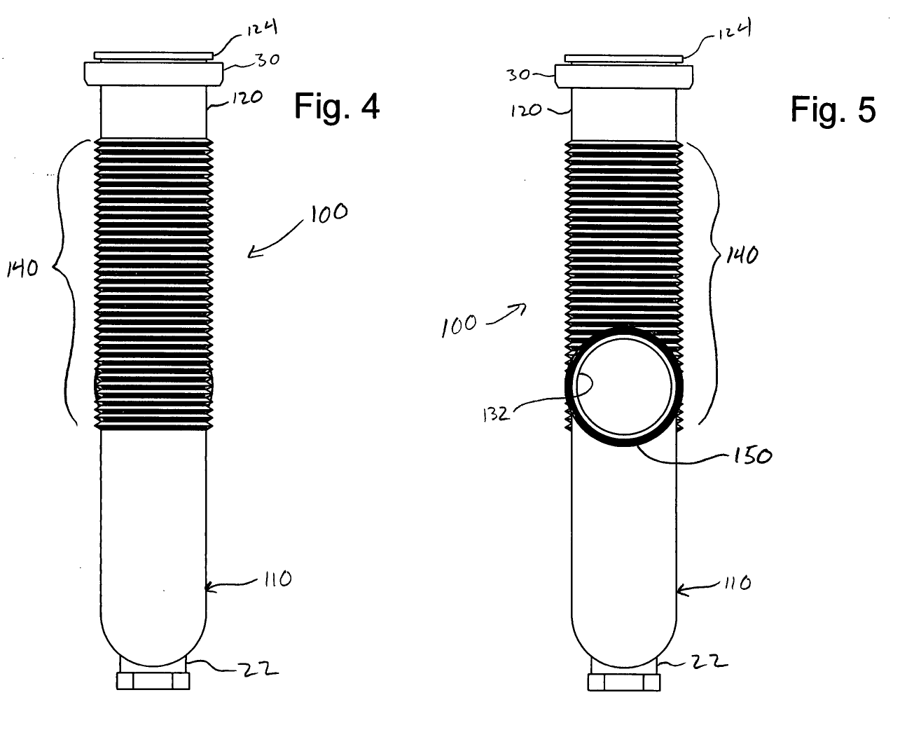

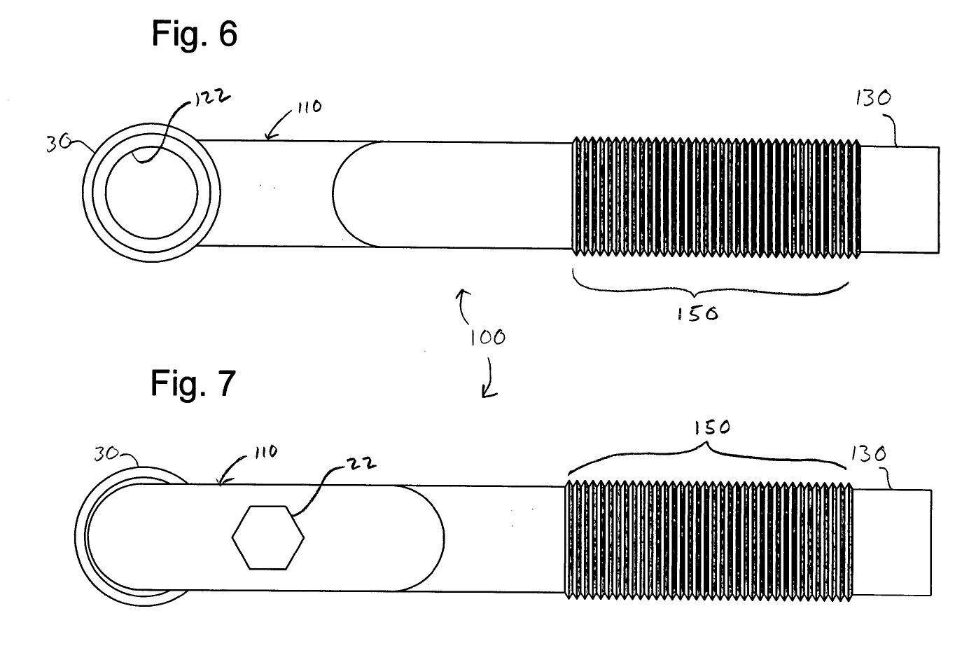

FIG. 4 is a front elevational view of the device 100 illustrated in FIG. 3. FIG. 5 is a rear elevational view of the same device 100. FIGS. 6 and 7 illustrate top and bottom view of the device 100, respectively. FIGS. 3-7 illustrate a nut 30 positioned in proximity to the inlet 122 of the device 100. The nut 30 may be threaded onto the device 100 by slipping it over the outlet 132 and threading it along the tubular structure of the device 100 until it meets flange 124. In the embodiment illustrated in FIG. 3, flange 124 forms the terminus of the inlet arm 120. Preferably, the device is formed of a rigid yet slightly yielding material such as plastic. Preferred plastic materials include polyvinyl chloride, polyethylene, and polypropylene, or combinations thereof. Due to the slight yielding nature of the preferred material, the nut 30 may be slipped over the end of the inlet arm 120 of the device despite the fact that the flange 124 is of greater diameter than the aperture (not shown) in the nut 30.

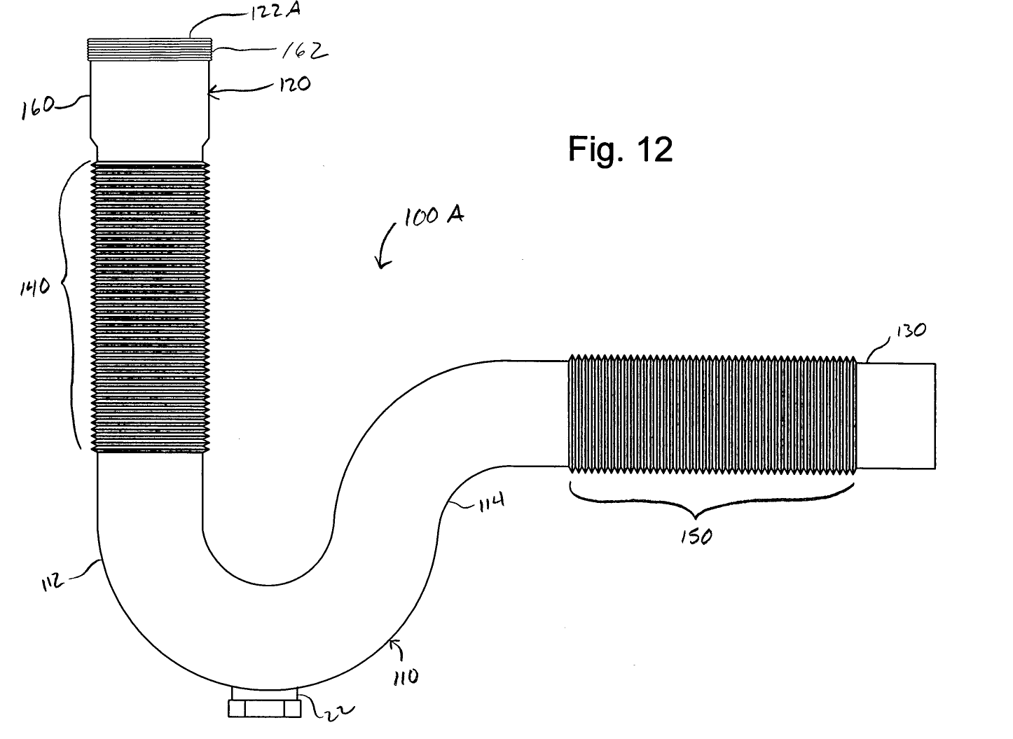

FIG. 12 illustrates an alternative embodiment wherein the inlet 122A of the device 100A comprises a slip extension fitting 160 for receiving the unthreaded end of a drain tail piece. In order to accommodate the diameter of the drain tail piece, the walls of the inlet arm 120 are flared slightly outward for receiving the tail piece.

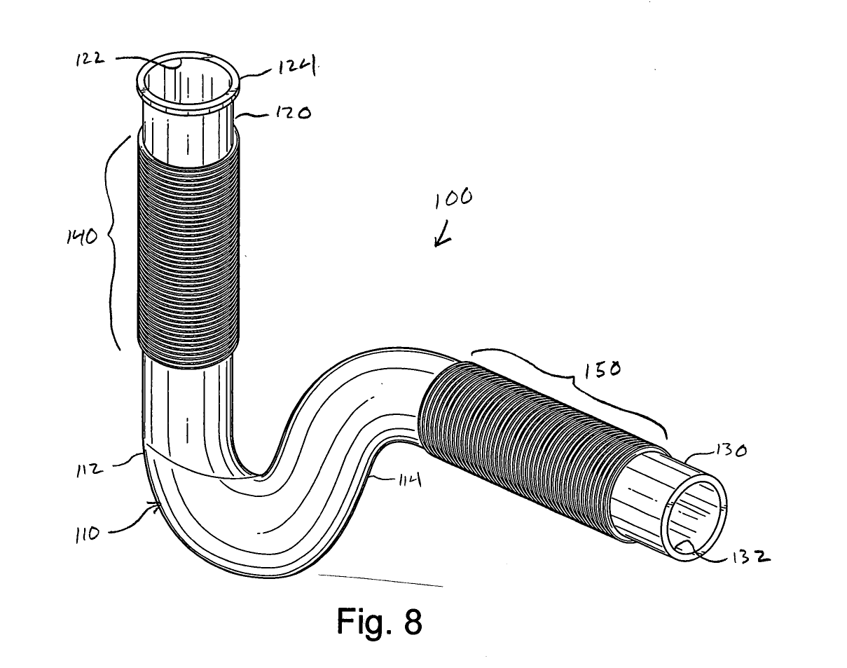

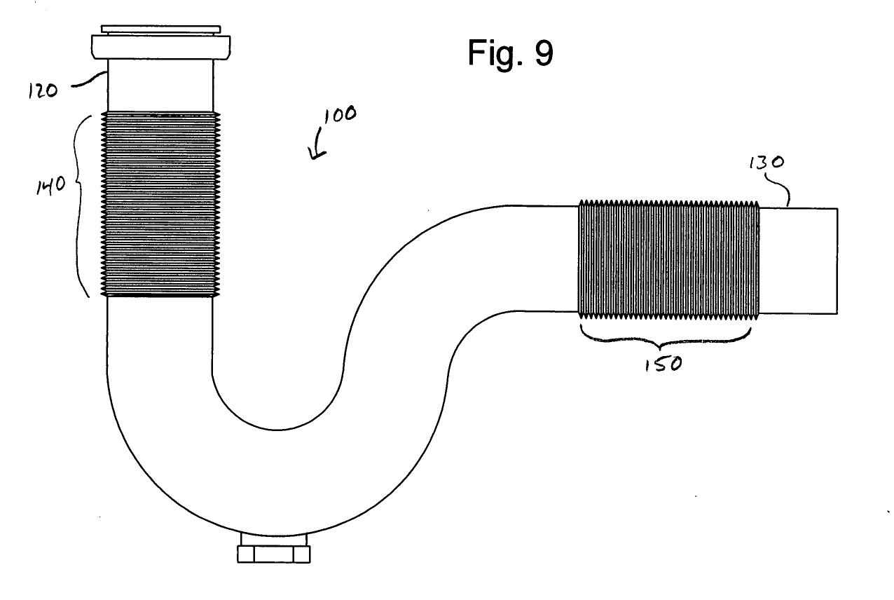

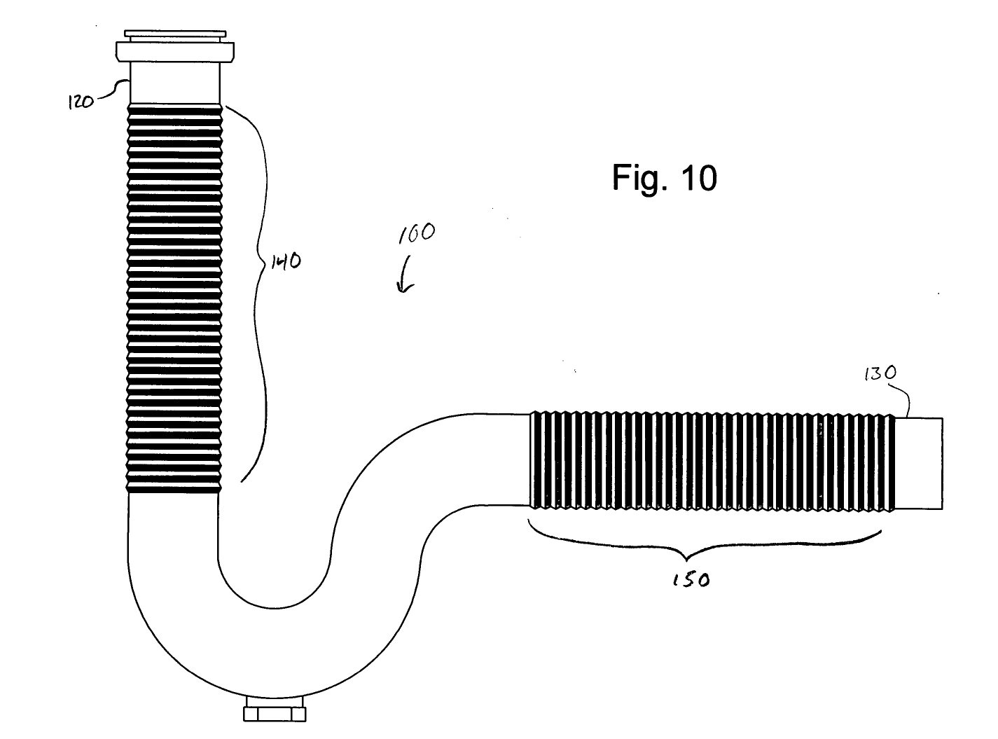

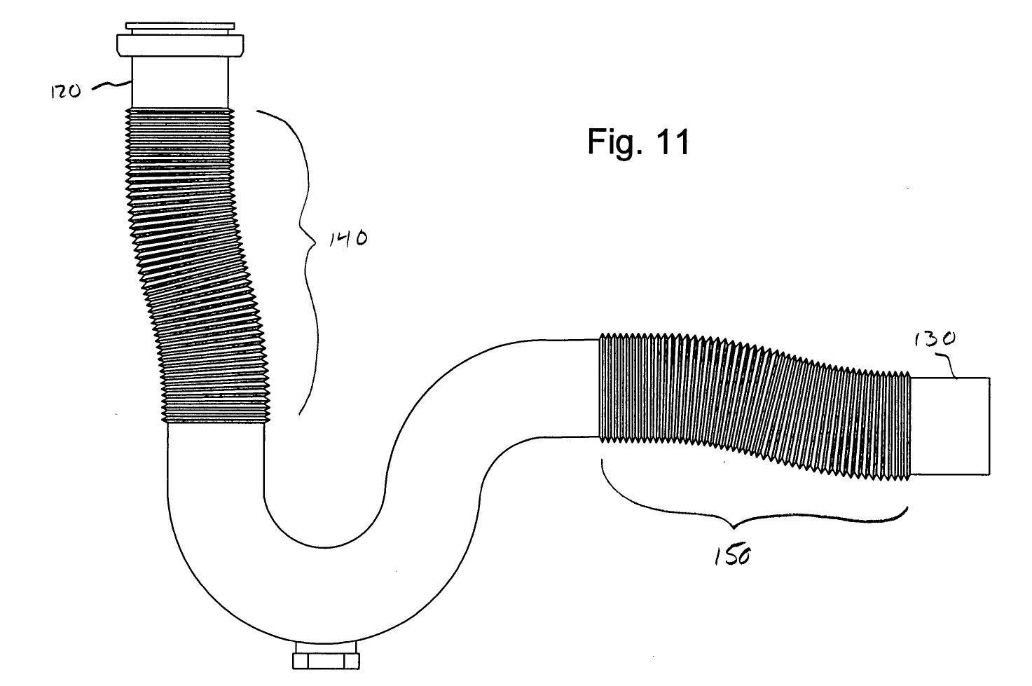

FIG. 8 is a perspective view of the device of FIGS. 3-7. FIG. 9 illustrates the device of FIGS. 3-8 wherein the flexible and extendable sections 140 and 150 are axially compressed, thereby reducing the length of the inlet 120 and outlet 130 arms. FIG. 10 is an illustration of the device in FIGS. 3-9 wherein the flexible and extendable sections 140 and 150 are axially extended, thereby lengthening the inlet arm 120 and outlet arm 130. FIG. 11 is an illustration of the device in FIGS. 3-10 wherein the flexible and extendable sections 140 and 150 are flexed, thereby extending and flexing portions of certain corrugations, allowing the ends 122 and 132 of the inlet arm 120 and outlet arm 130 to deviate from their respective longitudinal axes.

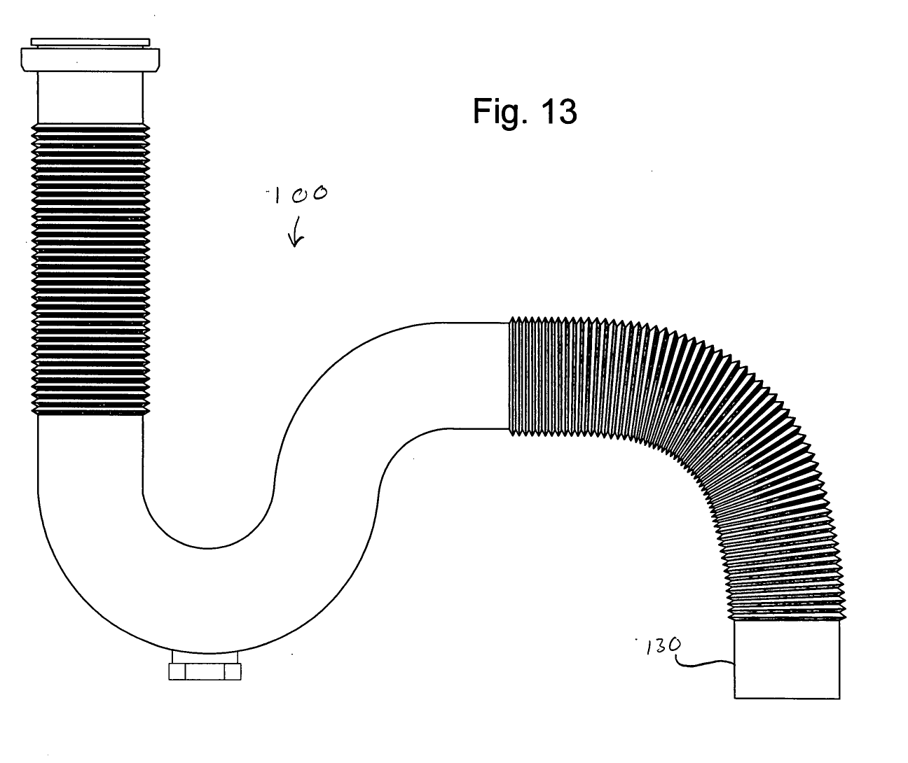

FIG. 13 illustrates the device 100 of the present invention wherein the outlet arm 130 is flexed downward to meet a drain outlet (not shown) projecting from the floor of a lavatory or other facility, thereby creating an S-trap configuration.

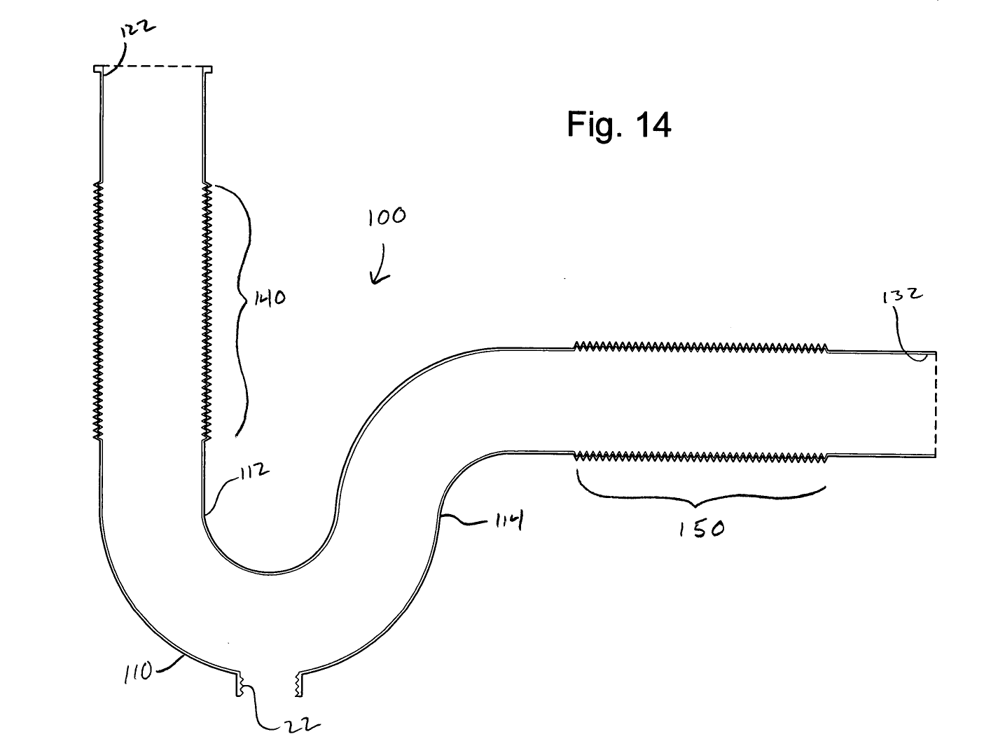

FIGS. 3-13 illustrate the adaptability and ease through which a unitary, flexible and extensible plumbing trap device 100 can be employed to meet a variety of spatial arrangements. FIG. 14 is a longitudinal, central sectional view of the plumbing trap device 100 of FIG. 3, showing a hollow bore throughout the device as well as an approximation of the wall thickness of the device.

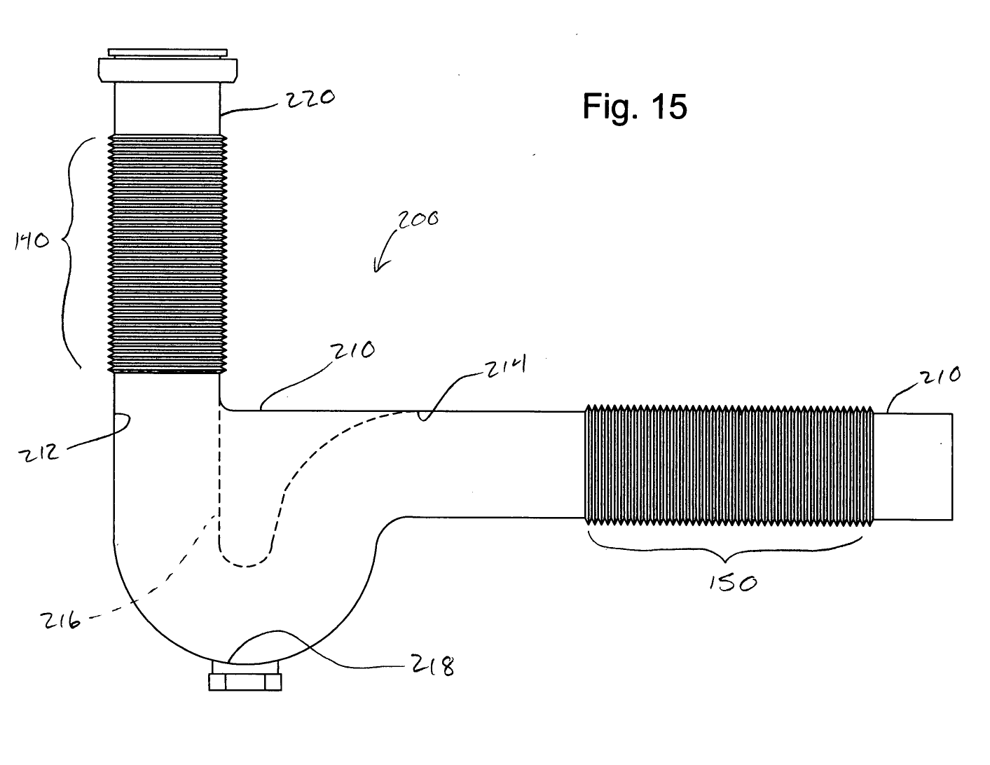

FIG. 15 is a side elevational view of an alternative embodiment of a plumbing trap 200 wherein the trap section comprises a vessel 210 having two transversely opposed openings 212 and 214 in communication with an upper portion of vessel 210. The openings 212 and 214 are separated from one another by a wall or septum structure 216 dividing the upper portion of the vessel 210 into chambers connected to one another through a gap 218 in a lower portion of the vessel 210. As shown, an inlet arm 220 projects upward from opening 212 and an outlet arm 210 projects horizontally from opening 214.

In use, the inlet arm 120 of the plumbing trap device 100 is attached to the tail piece of a drain (not shown) in one of two manners. In the case of a drain tail piece comprising a smoothed side tube with no specialized attachment means at the terminus such as threads or flanges, a plumbing trap device 100 of the present invention should be provided with a slip extension 160 for receiving a portion of the end of the tail piece. The slip extension 160 is secured to the tail piece using a gasket and nut (see 30B and 32A in FIG. 1) common in the prior art. First, the nut 30B is slipped onto the tail piece with the open end pointing downward, then a gasket 32A is slipped onto the tail piece with the narrow end pointing downward. Then, the slip extension portion 160 of the inlet arm 120 is raised to enclose the end portion of the tail piece. The gasket 32A is then pushed downward to meet the end of the slip extension 160 and the nut 30B is slid downward along the exterior of the tail piece and turned so the interior threads (not shown) of the nut 30B engage the exterior threads 162 of the slip extension 160. The nut 30B is then tightened squeezing the gasket 32A against the end of the slip extension 160 and compressing the gasket 32A to form a seal.

If the trap portion 110 of the device 110 is provided with a clean out plug 22, the nut covering the plugged hole should be engaged, thereby closing the hole.

Typically, the outlet arm 130 comprises a straight sided tube at the terminus which may be pushed into the drain outlet. Prior to pushing the end of the outlet arm 130 into the drain outlet, a nut is slipped onto the outlet arm 130 followed by a gasket. The outlet arm 130 is then slid into the drain outlet. The gasket pushed against the end of the drain outlet and the nut engaged with the threads on the outside of drain outlet. As with the connection described above between the tail piece and the inlet tube 120 comprising a slip extension 160, upon tightening the nut the gasket is compressed against the sides of the outlet arm 130 and against the end of the drain outlet thereby creating a friction seal to fix the outlet arm 130 in engagement with the drain outlet.

Because of the flexible and extensible sections 140 and 150 provided with the inlet arm 120 and outlet arm 130 the device 100 may be readily positioned with minimal stress placed upon the aforementioned connections.

It is to be understood that while certain forms of this invention have been illustrated and described, it is not limited thereto except insofar as such limitations are included in the following claims and allowable equivalents thereof.

1. A plumbing trap device adapted for connecting a drain tail piece to a drain outlet, said device comprising:
a unitary tubular element having a first end and an opposing second end, said tubular element comprising a trap section intermediate to said ends,
a first annular corrugated section and a second annular corrugated section, each of said annular corrugated sections comprising a plurality of folds, said first annular corrugated section disposed between said first end and said trap section, said second annular corrugated section disposed between said trap section and said second end.

2. The plumbing trap device of claim 1 wherein each of said annular corrugated sections are flexible.

3. The plumbing trap device of claim 1 wherein each of said annular corrugated sections are longitudinally compressible and extendible.

4. The plumbing trap device of claim 1 wherein said trap section comprises a U-shaped portion of said tubular element.

5. The plumbing trap device of claim 1 wherein said trap section comprises a U-shaped tubular structure having a pair of spaced legs extending vertically upwardly from a generally horizontal lower section.

6. The plumbing trap device of claim 1 wherein said trap section comprises a vessel having two transversely opposed openings in communication with an upper portion of said vessel, said openings separated from one another by a structure dividing said upper portion into chambers connected to one another through a gap in said structure in a lower portion of said vessel.

7. The plumbing trap device of claim 1 wherein said tubular element comprises a plastic tube.

8. The plumbing trap device of claim 1 wherein said tubular element comprises polyvinyl chloride.

9. A unitary, tubular body having a continuous bore therethrough for the conveyance of a fluid, said body including:
an inlet arm, said inlet arm projecting downward from an open upper end to communicate with a first opening in a generally U-shaped trap, said inlet arm including a first flexible and extendable section disposed between said upper end and said trap,
an outlet arm in communication with a second opening in said trap, said outlet arm terminating at an open lower end, said outlet arm including a second flexible and extendable section disposed between said trap and said lower end.

10. The tubular body of claim 9 wherein said first section comprises a plurality of corrugations.

11. The tubular body of claim 9 wherein said second section comprises a plurality of corrugations.

12. The tubular body of claim 9 wherein said flexible and extendable sections each comprise a plurality of annular ribs alternating with annular channels.

13. The tubular body of claim 9 further comprising means for attaching said inlet arm in fluid communication to a first plumbing fixture whereby said inlet arm may receive fluid from said first plumbing fixture.

14. The tubular body of claim 9 further comprising means for attaching said outlet arm in fluid communication to a second plumbing fixture whereby said outlet arm may conduct fluid to said second plumbing fixture.

15. The tubular body of claim 9 wherein said first and second sections extend, compress and flex for attachment of said inlet arm to a first plumbing fixture and said outlet arm to a second plumbing fixture.

16. The plumbing trap device of claim 9 wherein said trap comprises a U-shaped tubular structure having a pair of spaced legs extending vertically upwardly from a generally horizontal lower section.

17. The plumbing trap device of claim 9 wherein said trap comprises a vessel having two transversely opposed openings in communication with an upper portion of said vessel, said openings separated from one another by a structure dividing said upper portion into chambers connected to one another in a lower portion of said vessel.

18. A plumbing trap device comprising:
a substantially tubular element having a continuous bore therethrough and comprising a generally U-shaped portion having a pair of spaced legs extending vertically upwardly from a generally horizontal lower section,
the first of said legs terminating in a first opening in communication with a drain, said first leg including a first corrugated section, and
the second of said legs joined in fluid communication to a generally horizontally disposed arm terminating in a second opening in communication with a waste outlet, said second leg including a second corrugated section.

19. The device of claim 17 wherein said corrugated sections each comprise a plurality of annular ribs alternating with annular channels.

20. The device of claim 17 wherein said lower section includes a closeable aperture in communication with the interior of said lower section.
